(19) United States
(12) Patent Application Publication
(10) Pub. No.: US 2023/0133738 A1
(43) Pub. Date: May 4, 2023

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 17/918,778

(22) PCT Filed: Apr. 15, 2020
(86) PCT No.: PCT/JP2020/016636

§ 371 Date: Oct. 13, 2022

(51) Int. Cl. H04W 72/0446; H04L 5/00

(52) U.S. Cl. CPC H04W 72/0446; H04L 5/0053

(57) ABSTRACT

A terminal according to an aspect of the present disclosure includes: a control section that determines a default spatial relation to be applied to multi-slot transmission on the basis of a spatial relation to be applied to one or more slots of the multi-slot transmission; and a transmitting section that performs the multi-slot transmission by using a spatial domain transmission filter based on the default spatial relation. According to an aspect of the present disclosure, multi-slot transmission/reception can be appropriately controlled.

### TECHNICAL FIELD

The present disclosure relates to a terminal, a radio communication method, and a base station in next-generation mobile communication systems.

### BACKGROUND ART

In the universal mobile telecommunications system (UMTS) network, the specifications of long term evolution (LTE) have been drafted for the purpose of further increasing data rates, providing low delays, and so on (see Non Patent Literature 1). In addition, the specifications of LTE-Advanced (third generation partnership project (3GPP) Release (Rel) 10 to 14) have been drafted for the purpose of further increasing capacity and advancement of LTE (3GPP Rel. 8 and 9).

Successor systems to LTE (for example, also referred to as 5th generation mobile communication system (5G), 5G+ (plus), 6th generation mobile communication system (6G), New Radio (NR), or 3GPP Rel. 15 or later) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010.

### SUMMARY OF INVENTION

### Technical Problem

In 3GPP Rel. 15/16 NR, the support of repeated transmission over a plurality of slots (multiple slots) is studied. For example, a base station (a network (NW), or gNB) may repeatedly perform DL transmission. A user terminal (user equipment (UE)) may repeatedly perform UL transmission.

Further, in NR, a default spatial relation is studied as a spatial relation that the UE uses when a spatial relation cannot be used for UL transmission. The default spatial relation is derived with reference to a specific spatial relation, a transmission configuration indication state (TCI state), etc.

For the above-described multi-slot transmission, there is a possibility that the TCI state, etc. of the reference destination of the default spatial relation change in the course of transmission. However, what kind of default spatial relation to apply to repeated transmission has not yet been studied. If this is not clarified, repeated transmission cannot be appropriately performed. If repeated transmission is not appropriately performed, a reduction in throughput or a degradation in communication quality may be caused.

Thus, an object of the present disclosure is to provide a terminal, a radio communication method, and a base station that can appropriately control multi-slot transmission/reception.

### Solution to Problem

A terminal according to an aspect of the present disclosure includes: a control section that determines a default spatial relation to be applied to multi-slot transmission on the basis of a spatial relation to be applied to one or more slots of the multi-slot transmission; and a transmitting section that performs the multi-slot transmission by using a spatial domain transmission filter based on the default spatial relation.

### Advantageous Effects of Invention

According to an aspect of the present disclosure, multi-slot transmission/reception can be appropriately controlled.

### BRIEF DESCRIPTION OF DRAWINGS

FIGS. 1A to 1C are diagrams illustrating examples of a default spatial relation of multiple slots according to an embodiment.

FIG. 2 is a diagram illustrating an exemplary schematic configuration of a radio communication system according to an embodiment.

FIG. 3 illustrates one example of the configuration of a base station according to an embodiment.

FIG. 4 illustrates one example of the configuration of user terminal according to an embodiment.

FIG. 5 illustrates one example of a hardware configuration of a base station and a user terminal according to an embodiment.

### DESCRIPTION OF EMBODIMENTS

### TCI, Spatial Relation, and QCL

In NR, it has been studied to control reception processing (for example, at least one of reception, demapping, demodulation, and decoding) and transmission processing (for example, at least one of transmission, mapping, precoding, modulation, and coding) in UE of at least one of a signal and a channel (expressed as a signal/channel) based on a transmission configuration indication state (TCI state).

The TCI state may represent what is applied to a downlink signal/channel. One corresponding to the TCI state applied to an uplink signal/channel may be expressed as a spatial relation.

The TCI state is information regarding a quasi-co-location (QCL) of the signal/channel, and may also be referred to as, for example, a spatial Rx parameter, spatial relation information, or the like. The TCI state may be configured in the UE for each channel or each signal.

The QCL is an indicator indicating a statistical property of a signal/channel. For example, a case where one signal/channel and another signal/channel have a QCL relation may mean that it is possible to assume that at least one of Doppler shift, Doppler spread, an average delay, a delay spread, and a spatial parameter (for example, a spatial Rx parameter) is identical (in QCL with respect to at least one of these) between the plurality of different signals/channels.

Note that the spatial Rx parameter may correspond to a reception beam of the UE (for example, a reception analog beam), and the beam may be specified based on spatial QCL. The QCL (or at least one element of the QCL) in the present disclosure may be replaced with spatial QCL (sQCL).

A plurality of types of QCL (QCL types) may be defined. For example, four QCL types A to D with different parameters (or parameter sets) that can be assumed to be the same may be provided.

It may be referred to as a QCL assumption for the UE to assume that a certain control resource set (CORESET), channel, or reference signal has a specific QCL (for example, QCL type D) relation with another CORESET, channel, or reference signal.

The UE may determine at least one of a transmission beam (Tx beam) and a reception beam (Rx beam) of a signal/channel based on a TCI state of the signal/channel or the QCL assumption.

The TCI state may be, for example, information regarding the QCL of a target channel (in other words, a reference signal (RS) for the channel) and another signal (for example, another RS). The TCI state may be configured (given in instruction) by higher layer signaling, physical layer signaling, or a combination thereof.

In the present disclosure, the higher layer signaling may be any of, for example, radio resource control (RRC) signaling, medium access control (MAC) signaling, broadcast information, and the like, or a combination thereof.

For the MAC signaling, for example, a MAC Control Element (MAC CE), a MAC Protocol Data Unit (PDU), or the like may be used. The broadcast information may be, for example, a master information block (MIB), a system information block (SIB), remaining minimum system information (RMSI), other system information (OSI), or the like.

The physical layer signaling may be, for example, Downlink Control Information (DCI).

A channel for which a TCI state or spatial relation is configured (specified) may be, for example, at least one of a Physical Downlink Shared Channel (PDSCH), a Physical Downlink Control Channel (PDCCH), a Physical Uplink Shared Channel (PUSCH), and a Physical Uplink Control Channel (PUCCH).

Furthermore, an RS having a QCL relation with the channel may be, for example, at least one of a Synchronization Signal Block (SSB), a Channel State Information Reference Signal (CSI-RS)), a measurement reference signal (Sounding Reference Signal (SRS)), a tracking CSI-RS (also referred to as a Tracking Reference Signal (TRS)), and a QCL detection reference signal (also referred to as a QRS).

The SSB is a signal block including at least one of a primary synchronization signal (PSS), a secondary synchronization signal (SSS), and a broadcast channel (physical broadcast channel (PBCH)). The SSB may be referred to as an SS/PBCH block.

An information element of a TCI state configured by higher layer signaling (“TCI-state IE” of RRC) may include a TCI state ID and one or more pieces of QCL information (“QCL-Info”). The QCL Information may include at least one of information regarding the RS having the QCL relation (RS related information) and information indicating a QCL type (QCL type information). The RS related information may include information such as an index of the RS (for example, an SSB index or a non-zero-power (NZP) CSI-RS resource identifier (ID)), an index of a cell where the RS is located, or an index of a bandwidth part (BWP) where the RS is located.

### TCI State for PDSCH

Information regarding QCL between a PDSCH (or a DMRS antenna port associated with the PDSCH) and a certain DL-RS may be referred to as a TCI state for the PDSCH, or the like.

In the UE, M (M ≥ 1) TCI states for PDSCH (QCL information for M PDSCHs) may be provided in notification (configured) by higher layer signaling. Note that the number M of TCI states configured in the UE may be limited by at least one of the UE capability and the QCL type.

DCI used for PDSCH scheduling may include a field (which may be referred to as, for example, a TCI field, a TCI state field, or the like) indicating a TCI state for the PDSCH. The DCI may be used for PDSCH scheduling of one cell, and may be referred to as, for example, DL DCI, DL assignment, DCI format 1_0, DCI format 1_1, or the like.

Whether or not the TCI field is included in the DCI may be controlled by information of which the UE is notified from the base station. The information may be information (for example, TCI presence information, in-DCI TCI presence information, a higher layer parameter TCI-PresentInDCI) indicating whether the TCI field is present or absent in the DCI. The information may be configured in the UE by, for example, higher layer signaling.

When more than eight types of TCI states are configured in the UE, MAC CE may be used to activate (or specify) eight or less types of TCI states. The MAC CE may be referred to as a TCI states activation/deactivation for UE-specific PDSCH MAC CE. A value of the TCI field in the DCI may indicate one of the TCI states activated by MAC CE.

In a case where the TCI presence information configured as “enabled” is configured in the UE for a CORESET for scheduling a PDSCH (CORESET used for PDCCH transmission for scheduling the PDSCH), the UE may assume that the TCI field is present in the DCI format 1_1 of the PDCCH transmitted on the CORESET.

In a case where the TCI presence information is not configured for the CORESET for scheduling a PDSCH, or the PDSCH is scheduled by the DCI format 1_0, in a case where a time offset between reception of DL DCI (DCI for scheduling the PDSCH) and reception of a PDSCH corresponding to the DCI is greater than or equal to a threshold value, the UE, to determine QCL of a PDSCH antenna port, may assume that a TCI state or a QCL assumption for the PDSCH is the same as a TCI state or a QCL assumption applied to a CORESET used for PDCCH transmission for scheduling the PDSCH.

When the TCI presence information is set to “enabled”, the TCI field in the DCI in the component carrier (CC) for scheduling (the PDSCH) indicates the activated TCI state in the scheduled CC or DL BWP, and when the PDSCH is scheduled by DCI format 1_1, the UE may use the TCI with the DCI and according to the value of the TCI field in the detected PDCCH in order to determine the QCL of the PDSCH antenna port. When the time offset between the reception of the DL DCI (scheduling the PDSCH) and the PDSCH corresponding to the DCI (PDSCH scheduled by the DCI) is equal to or greater than the threshold value, the UE may assume that the DM-RS port of the PDSCH of the serving cell is QCL with the RS in the TCI state with respect to the QCL type parameter given by the indicated TCI state.

When a single-slot PDSCH is configured in the UE, the indicated TCI state may be based on the activated TCI state in the slot having the scheduled PDSCH. When a multi-slot PDSCH is configured in the UE, the indicated TCI state may be based on the activated TCI state in the first slot having the scheduled PDSCH, and the UE may expect that it is the same across the slots having the scheduled PDSCH. When the UE is configured with a CORESET associated with a search space set for cross-carrier scheduling, when the TCI presence information is set to “enabled” for the CORESET for the UE and at least one of the TCI states configured for the serving cell scheduled by a search space set includes QCL type D, the UE may assume that the time offset between the detected PDCCH and the PDSCH corresponding to the PDCCH is equal to or greater than the threshold value.

In both a case where the TCI information in the DCI (higher layer parameter TCI-PresentInDCI) is set to “enabled” and a case where the TCI information in the DCI is not configured in the RRC connection mode, when the time offset between reception of DL DCI (DCI for scheduling the PDSCH) and the corresponding PDSCH (PDSCH scheduled by the DCI) is less than the threshold value, the UE may assume that the DM-RS port of the PDSCH of the serving cell has a minimum (lowest) CORESET-ID in a newest (latest) slot in which one or more CORESETs in an active BWP of the serving cell are monitored by the UE, and is in QCL with the RS related to a QCL parameter used for QCL indication of the PDCCH of the CORESET associated with a monitored search space. This RS may be referred to as a default TCI state of the PDSCH or a default QCL assumption of the PDSCH.

The time offset between the reception of the DL DCI and the reception of the PDSCH corresponding to the DCI may be referred to as a scheduling offset.

Further, the above-mentioned threshold value may be referred to as QCL time duration “timeDurationForQCL”, “threshold”, “threshold for offset between a DCI indicating a TCI state and PDSCH scheduled by the DCI”, “threshold-Sched-Offset”, a schedule offset threshold value, a scheduling offset threshold value, or the like.

The QCL time duration may be based on the UE capability, and may be based on, for example, the delay in decoding and beam switching of the PDCCH. The QCL time length may be a minimum time required for the UE to perform PDCCH reception and application of spatial QCL information received in the DCI for PDSCH processing. The QCL time length may be represented by the number of symbols for each subcarrier interval or may be represented by time (for example, µs). Information of the QCL time length may be reported from the UE to the base station as UE capability information, or may be configured from the base station to the UE by using higher layer signaling.

For example, the UE may assume that the DMRS ports of PDSCH are in QCL with the DL-RS based on the TCI state activated for the CORESET corresponding to the lowest CORESET-ID. The latest slot may be, for example, a slot that receives the DCI for scheduling the PDSCH.

Note that, the CORESET-ID may be an ID (ID for identifying the CORESET, controlResourceSetId) set by an RRC information element “ControlResourceSet”.

When no CORESET is set for a CC, the default TCI state may be an activated TCI state applicable to the PDSCH in the active DL BWP for the CC and having the lowest ID.

In Rel. 16 or later, when the PDSCH and the PDCCH for scheduling the PDSCH are in different component carriers (CCs) (cross-carrier scheduling), if a delay from the PDCCH to the PDSCH (PDCCH-to-PDSCH delay) is shorter than the QCL time length, or if the TCI state is not in the DCI for the scheduling, the UE may acquire the QCL assumption for the scheduled PDSCH from the active TCI state applicable to the PDSCH in the active BWP of the scheduled cell and having the lowest ID.

### Spatial Relation for PUCCH

In the UE, a parameter (PUCCH configuration information, PUCCH-Config) used for PUCCH transmission may be configured by higher layer signaling (for example, Radio Resource Control (RRC) signaling). The PUCCH configuration information may be configured for each partial band (for example, an uplink Bandwidth Part (BWP)) in a carrier (also referred to as a cell and a Component Carrier (CC)).

The PUCCH configuration information may include a list of PUCCH resource set information (for example, PUCCH-ResourceSet) and a list of PUCCH spatial relation information (for example, PUCCH-SpatialRelationInfo).

The PUCCH resource set information may include a list (for example, resourceList) of a PUCCH resource index (ID, for example, PUCCH-ResourceId).

Furthermore, when the UE does not have a dedicated PUCCH resource configuration information (for example, a dedicated PUCCH resource configuration) provided by the PUCCH resource set information in the PUCCH configuration information (before RRC setup), the UE may determine a PUCCH resource set on the basis of a parameter (for example, pucch-ResourceCommon) in the system information (for example, System Information Block Type 1 (SIB1) or Remaining Minimum System Information (RMSI)). The PUCCH resource set may include 16 PUCCH resources.

On the other hand, when the UE has the dedicated PUCCH resource configuration information (UE-dedicated uplink control channel configuration, dedicated PUCCH resource configuration) (after RRC setup), the UE may determine the PUCCH resource set according to the number of UCI information bits.

The UE may determine one PUCCH resource (index) in the PUCCH resource set (for example, a cell-specific PUCCH resource set or a PUCCH resource set determined for individual UE) based on at least one of a value of a field (for example, a PUCCH resource indicator field) in Downlink Control Information (DCI) (for example, the DCI format 1_0 or 1_1 used for PDSCH scheduling), the number of CCEs (N_{CCE}) in a control resource set (control resource set (CORESET)) for reception of a PDCCH that carries the DCI, and an index (n_{CCE,0}) of a head (first) CCE of the reception of the PDCCH.

The PUCCH spatial relation information (for example, the RRC information element “PUCCH-spatialRelationInfo”) may indicate a plurality of candidate beams (spatial domain filters) for PUCCH transmission. The PUCCH spatial relation information may indicate a spatial relation between a reference signal (RS) and a PUCCH.

The list of the PUCCH spatial relation information may include several elements (PUCCH spatial relation information Information Element (IE)). Each piece of the PUCCH spatial relation information may include, for example, at least one of an index (ID, for example, pucch-SpatialRelationInfoId) of the PUCCH spatial relation information, an index (ID, for example, servingCellId) of the serving cell, and information related to the RS (reference RS) that has a spatial relation with the PUCCH.

For example, the information regarding the RS may be an SSB index, a CSI-RS index (for example, an NZP-CSI-RS resource configuration ID), or an SRS resource ID and an ID of the BWP. The SSB index, the CSI-RS index, and the SRS resource ID may be associated with at least one of a beam, a resource, and a port selected by measurement of a corresponding RS.

When more than one piece of the spatial relation information regarding the PUCCH is configured, the UE may perform control so that one piece of the PUCCH spatial relation information is active with respect to one PUCCH resource at a given time, on the basis of a PUCCH spatial relation Activation/Deactivation MAC CE.

The PUCCH spatial relation Activation/Deactivation MAC CE of Rel-15 NR is expressed by a total of three Octets (8 bits × 3 = 24 bits) of Octets (Octs) 1-3.

The MAC CE may include information such as an application target serving cell ID (“Serving Cell ID” field), a BWP ID (“BWP ID” field), and a PUCCH resource ID (“PUCCH Resource ID” field).

Furthermore, the MAC CE includes a field of “Si” (i = 0-7). When a field of a certain Si indicates 1, the UE activates the spatial relation information of a spatial relation information ID #i. When a field of a certain Si indicates 0, the UE deactivates the spatial relation information of the spatial relation information ID #i.

The UE may activate PUCCH relation information specified by a MAC CE 3 ms after transmitting an acknowledgment (ACK) for the MAC CE activating PUCCH spatial relation information.

### Spatial Relation for SRS and PUSCH

In Rel.15 NR, the UE may receive information (SRS configuration information, for example, a parameter in the RRC control element “SRS-Config”) used for transmission of a measurement reference signal (for example, a sounding reference signal (SRS)).

Specifically, the UE may receive at least one of information related to one or a plurality of SRS resource sets (SRS resource set information, for example, the RRC control element “SRS-ResourceSet”) and information related to one or a plurality of SRS resources (SRS resource information, for example, the RRC control element “SRS-Resource”).

One SRS resource set may be associated with a predetermined number of SRS resources (a predetermined number of SRS resources may be grouped). Each SRS resource may be specified by an SRS Resource Indicator (SRI) or an SRS resource Identifier (ID).

The SRS resource set information may include information of an SRS resource set ID (SRS-ResourceSetId), a list of SRS resource IDs (SRS-ResourceId) used in the resource set, an SRS resource type (for example, one of periodic SRS, semi-persistent SRS, and aperiodic CSI (Aperiodic SRS)), and SRS usage.

Here, the SRS resource type may indicate any one of a periodic SRS (P-SRS), a semi-persistent SRS (SP-SRS), and an aperiodic SRS (A-SRS). Note that the UE may transmit a P-SRS and an SP-SRS periodically (or periodically after activated), and transmit an A-SRS based on an SRS request in the DCI.

Further, the usage (the RRC parameter “usage” or the Layer-1 (L1) parameter “SRS-SetUse”) may be, for example, beam management, codebook (CB), noncodebook (NCB), antenna switching, or the like. SRS used for the codebook or the non-codebook may be used to determine a precoder for codebook-based or non-codebook-based PUSCH transmission based on SRI.

For example, in the case of the codebook-based transmission, the UE may determine the precoder for the PUSCH transmission on the basis of the SRI, a Transmitted Rank Indicator (TRI), and a Transmitted Precoding Matrix Indicator (TPMI). For the non-codebook based transmission, the UE may determine a precoder for PUSCH transmission based on the SRI.

The SRS resource information may include an SRS resource ID (SRS-ResourceId), the number of SRS ports, an SRS port number, transmission Comb, SRS resource mapping (for example, time and/or frequency resource position, resource offset, resource periodicity, the number of repetitions, the number of SRS symbols, and SRS bandwidth), hopping related information, an SRS resource type, a sequence ID, and SRS spatial relation information.

The SRS spatial relation information (for example, the RRC information element “spatialRelationInfo”) may indicate spatial relation information between a predetermined reference signal and the SRS. The predetermined reference signal may be at least one of a Synchronization Signal/Physical Broadcast Channel (SS/PBCH) block, a Channel State Information Reference Signal (CSI-RS), or and SRS (for example, another SRS). The SS/PBCH block may be referred to as a synchronization signal block (SSB) .

The SRS spatial relation information may include at least one of an SSB index, a CSI-RS resource ID, and an SRS resource ID as an index of the predetermined reference signal.

Note that, in the present disclosure, an SSB index, an SSB resource ID, and an SSB resource indicator (SSBRI) may be replaced with each other. Furthermore, a CSI-RS index, a CSI-RS resource ID, and a CSI-RS resource indicator (CRI) may be replaced with each other. Further, an SRS index, an SRS resource ID and an SRI may be replaced with each other.

The SRS spatial relation information may include a serving cell index, a bandwidth part (BWP) index (BWP ID), and the like corresponding to the predetermined reference signal.

When spatial relation information regarding the SSB or CSI-RS and the SRS is configured for a certain SRS resource, the UE may transmit the SRS resource by using the same spatial domain filter (spatial domain transmission filter) as a spatial domain filter (spatial domain reception filter) for receiving the SSB or CSI-RS. In this case, the UE may assume that the UE reception beam of the SSB or CSI-RS is the same as the UE Tx beam of the SRS.

For a certain SRS (target SRS) resource, when spatial relation information regarding another SRS (reference SRS) and the SRS (target SRS) is configured, the UE may transmit the target SRS resource by using the same spatial domain filter (spatial domain transmission filter) as a spatial domain filter (spatial domain transmission filter) for transmitting the reference SRS. That is, in this case, the UE may assume that a UE transmission beam of the reference SRS is the same as a UE Tx beam of the target SRS.

The UE may determine the spatial relation of the PUSCH scheduled by the DCI based on a value of a predetermined field (for example, SRS resource identifier (SRI) field) in the DCI (for example, DCI format 0_1). Specifically, the UE may use the spatial relation information (for example, the RRC information element “spatialRelationInfo”) of the SRS resource determined based on the value (for example, SRI) of the predetermined field for the PUSCH transmission.

When the codebook-based transmission is used for the PUSCH, in the UE, two SRS resources per SRS resource set may be configured by RRC, and one of the two SRS resources may be indicated by DCI (1-bit SRI field). When the non-codebook-based transmission is used for the PUSCH, in the UE, four SRS resources per SRS resource set may be configured by RRC, and one of the four SRS resources may be indicated by DCI (2-bit SRI field).

In NR of Rel. 16 or later, it is studied to explicitly perform notification of a common beam for both DL and UL. For example, a TCI state may be used as (or instead of) PUSCH spatial relation information. The TCI state may be at least one of a downlink TCI state (a DL TCI state), an uplink TCI state (a UL TCI state), and a unified TCI state.

Note that the UL TCI state may be replaced with spatial relation information (spatialrelationinfo). The unified TCI state may mean a TCI state used in common to both DL and UL.

In addition to an SSB index, a CSI-RS ID, and an SRS ID, a TCI state ID, a control resource set (CORESET) ID, or the like may be configured as an index of a reference RS of a spatial relation. UE in which a TCI state ID or a CORESET ID is configured as a spatial relation, when performing UL transmission on the basis of the spatial relation, may assume that the same spatial domain filter as that used for DL reception conforming to the TCI state ID or a TCI state ID corresponding to the CORESET ID is used for the UL transmission.

### Path-Loss RS

The Path-loss PL_{b},_{f},_{c}(q_{d}) [dB] in transmission power control of each of a physical uplink shared channel (PUSCH), a physical uplink control channel (PUCCH), and a measurement reference signal (sounding reference signal (SRS)) is calculated by the UE by using index q_{d} of a reference signal (an RS, or a Path-loss reference RS (PathlossReferenceRS)) for a downlink BWP associated with active UL BWP b of carrier f of serving cell c.

In the present disclosure, a Path-loss reference RS, a Path-loss (PL)-RS, index q_{d}, an RS used for Path-loss calculation, and an RS resource used for Path-loss calculation may be replaced with each other. In the present disclosure, calculation, estimation, measurement, and tracking may be replaced with each other.

The PL-RS may be at least one of DL RSs such as an SSB and a CSI-RS.

For accurate Path-loss measurement for transmission power control, in the UE of Rel. 15, up to 4 PL-RSs are configured by RRC signaling. Even in a case where the UL Tx beam (spatial relation) is updated by a MAC CE, the PL-RS cannot be updated by a MAC CE.

In the UE of Rel. 16, up to 64 PL-RSs are configured by RRC signaling, and one PL-RS is indicated (activated) by a MAC CE. The UE is required to track up to 4 active PL-RSs for all UL channels (an SRS, a PUCCH, and a PUSCH). Tracking a PL-RS may be calculating a Path-loss based on measurement of the PL-RS and retaining (storing) the Path-loss.

In a case where a TCI state for a PDCCH or a PDSCH is updated by a MAC CE, also the PL-RS may be updated to the TCI state.

### Default Spatial Relation and Default PL-RS

In Rel. 15 NR, individual MAC CEs of a MAC CE for activation/deactivation of a PUCCH spatial relation and a MAC CE for activation/deactivation of an SRS spatial relation are needed. The PUSCH spatial relation conforms to the SRS spatial relation.

In Rel. 16 NR, at least one of a MAC CE for activation/deactivation of a PUCCH spatial relation and a MAC CE for activation/deactivation of an SRS spatial relation may not be used.

A default spatial relation is studied as a spatial relation that the UE uses when a spatial relation cannot be used (for example, cannot be specified, is not designated, or is not activated) for UL transmission. Further, a default PL-RS is studied as a PL-RS used when a PL-RS cannot be used (the same as above) for UL transmission or when a default spatial relation is used.

For example, in a case where in FR2 neither a spatial relation nor a PL-RS for a PUCCH is configured or activated, default assumptions of the spatial relation and the PL-RS (a default spatial relation and a default PL-RS) are applied to the PUCCH. In a case where in FR2 neither a spatial relation nor a PL-RS for an SRS is configured or activated, default assumptions of the spatial relation and the PL-RS (a default spatial relation and a default PL-RS) are applied to the PUSCH scheduled by DCI format 0_1 and the SRS.

In a case where CORESETs are configured in an active DL BWP on a CC, the default spatial relation and the default PL-RS may conform to the TCI state or the QCL assumption of the CORESET having the smallest (lowest) CORESET ID in the active DL BWP. In a case where no CORESETs are configured in an active DL BWP on a CC, the default spatial relation and the default PL-RS may conform to the active TCI state having the smallest TCI state ID of PDSCHs in the active DL BWP.

In Rel. 15, the spatial relation of a PUSCH scheduled by DCI format 0_0 conforms to the spatial relation of the PUCCH resource having the smallest PUCCH resource ID among active spatial relations of PUCCHs on the same CC. Even in a case where no PUCCHs are transmitted on SCells, the network needs to update the PUCCH spatial relations on all SCells.

In Rel. 16, a PUCCH configuration for a PUSCH scheduled by DCI format 0_0 is not needed. A default spatial relation and a default PL-RS are applied to a PUSCH scheduled by DCI format 0_0.

In a case where a TCI state for a PDCCH or a PDSCH is updated by a MAC CE, also the PL-RS is updated to the TCI state.

Note that the default TCI state/default QCL assumption described above may mean a TCI state (QCL assumption) that the UE uses when a TCI state for DL reception cannot be used.

### Repetition Transmission

In Rel. 15/16 NR, the support of repeated transmission over a plurality of slots (multiple slots) is studied. For example, a base station (network (NW), gNB) may repeatedly transmit DL data (for example, downlink shared channel (PDSCH)) for a given number of times. Alternatively, a UE may repeatedly transmit UL data (for example, uplink shared channel (PUSCH)) for a given number of times.

Note that the repeating unit (for example, a slot) may be referred to as a transmission occasion or the like.

Further, also repeated transmission of PUCCHs, repeated transmission of SRSs, and the like over a plurality of slots are studied.

Meanwhile, in a case where the spatial relation/TCI state is updated for a PUCCH, a PUSCH, a PDCCH, a PDSCH, or the like by a MAC CE, the UE preferably matches the default spatial relation/TCI state/PL-RS to the updated spatial relation/TCI state as soon as possible.

However, what kind of default spatial relation/TCI state/PL-RS to apply to repeated transmission has not yet been studied. If this is not clarified, repeated transmission cannot be appropriately performed. If repeated transmission is not appropriately performed, a reduction in throughput or a degradation in communication quality may be caused.

Thus, the present inventors have conceived a method for appropriately determining a spatial relation/TCI state/PL-RS for repeated transmission. According to an aspect of the present disclosure, for example, the UE can appropriately switch a default spatial relation in accordance with updating of a TCI state based on a MAC CE.

Hereinafter, embodiments according to the present disclosure will be described in detail with reference to the drawings. A radio communication method according to each embodiment may be applied independently, or may be applied in combination with others.

Note that in the present disclosure, “A/B” may indicate “at least one of A and B”.

In the present disclosure, a panel, an uplink (UL) transmission entity, a TRP, spatial relation, a control resource set (CORESET), a PDSCH, a codeword, a base station, a predetermined antenna port (e.g., demodulation reference signal (DMRS) port), a predetermined antenna port group (e.g., DMRS port group), a predetermined group (e.g., code division multiplexing (CDM) group, predetermined reference signal group, and CORESET group), CORESET pool, and the like may be replaced with each other. Further, the TRP identifier (ID) and the TRP may be replaced with each other.

Further, the CORESET in the following embodiments may mean a CORESET associated with a BWP, or may mean a CORESET associated with (any BWP of) a cell.

In the present disclosure, the index, the ID, the indicator, the resource ID, and the like may be replaced with each other. In the present disclosure, a beam, a TCI, a TCI state, a DL TCI state, a UL TCI state, a unified TCI state, a QCL, a QCL assumption, a spatial relation, spatial relation information, an SRI, an SRS resource, a precoder, and the like may be replaced with each other. Further, TCI state ID #i (i being an integer) may be expressed as TCI #i.

In the present disclosure, a list, a group, a set, a subset, a cluster, and the like may be replaced with each other.

Hereinafter, in the present disclosure, a default spatial relation may be replaced with a default spatial relation for a PUSCH/PUCCH/SRS of repeated transmission, simply a default spatial relation for repeated transmission, or the like.

In the present disclosure, repeated transmission, multiple slots (multi-slot transmission), multiple subslots (multi-subslot transmission), and the like may be replaced with each other. Note that multi-slot transmission may mean UL transmission (for example, a PUCCH/PUSCH/SRS) that transmits the same UCI/TB/CW/data/RS, or may mean a plurality of UL transmissions triggered by one piece of DCI/MAC.

Further, the spatial relation (or default spatial relation) of the present disclosure may be replaced with a PL-RS (or a default PL-RS). That is, although the following embodiments mainly describe the determination of a spatial relation for repeated transmission, the present disclosure also supports the determination of a PL-RS for repeated transmission (for example, repeated transmission of a PUCCH/PUSCH/SRS).

### Radio Communication Method

In an embodiment, for a default spatial relation of multi-slot transmission, the UE may determine the spatial relation of each slot in accordance with at least one of the following:
(1) apply the spatial relation of the first slot of multiple slots to all the slots of the multiple slots;
(2) determine the spatial relation of each slot of multiple slots individually in the slot; and
(3) apply the spatial relation of the last slot of multiple slots to all the slots of the multiple slots.

The above (1) and (3) fall under using the default spatial relation of a specific slot of multiple slots as the default spatial relation of another slot of the multiple slots. The above (2) may fall under determining the default spatial relation of each slot of multiple slots in accordance with the (most recent) active TCI state (or the QCL assumption of the CORESET of the smallest CORESET ID) in the slot.

In the above (1), the UE may determine the default spatial relation of each slot on the basis of the RS resource index of the RS resource of QCL type D in the default spatial relation (or the TCI state or the QCL assumption referred to in the default spatial relation) of the first slot of the multiple slots. Further, in the above (1), the UE may assume that the spatial domain filter used to receive the RS resource of QCL type D in the default spatial relation (or the TCI state or the QCL assumption referred to in the default spatial relation) of the first slot of multiple slots and the spatial domain filter used for PUCCH transmission of each slot are the same.

In the case of the above (1), it can be guaranteed that the UE performs multi-slot transmission by using the same spatial relation. Therefore, the base station can receive multi-slot transmissions from the UE by using the same beam, or can perform in-phase synthesis on received signals/DMRSs of the slots; thus, an improvement in reception quality/channel estimation accuracy can be expected.

In the above (2), the UE may determine the default spatial relation of a slot of multiple slots on the basis of the RS resource index of the RS resource of QCL type D in the default spatial relation (or the TCI state or the QCL assumption referred to in the default spatial relation) of the slot. Further, in the above (2), the UE may assume that the spatial domain filter used to receive the RS resource of QCL type D in the default spatial relation (or the TCI state or the QCL assumption referred to in the default spatial relation) of a slot of multiple slots and the spatial domain filter used for PUCCH transmission of the slot are the same.

In the case of the above (2), when the reference destination (source) TCI state/QCL assumption of the default spatial relation is updated, the UE can quickly update the UL transmission beam. In a situation where the reference destination TCI state/QCL assumption is updated, since it is assumed that the optimal beam has changed, the UL beam is preferably updated to the optimal beam earlier.

In the above (3), the UE may determine the default spatial relation of each slot on the basis of the RS resource index of the RS resource of QCL type D in the default spatial relation (or the TCI state or the QCL assumption referred to in the default spatial relation) of the last slot of the multiple slots. Further, in the above (3), the UE may assume that the spatial domain filter used to receive the RS resource of QCL type D in the default spatial relation (or the TCI state or the QCL assumption referred to in the default spatial relation) of the last slot of multiple slots and the spatial domain filter used for PUCCH transmission of each slot are the same.

In the case of the above (3), it can be expected to obtain both the advantages of the above (1) and (2).

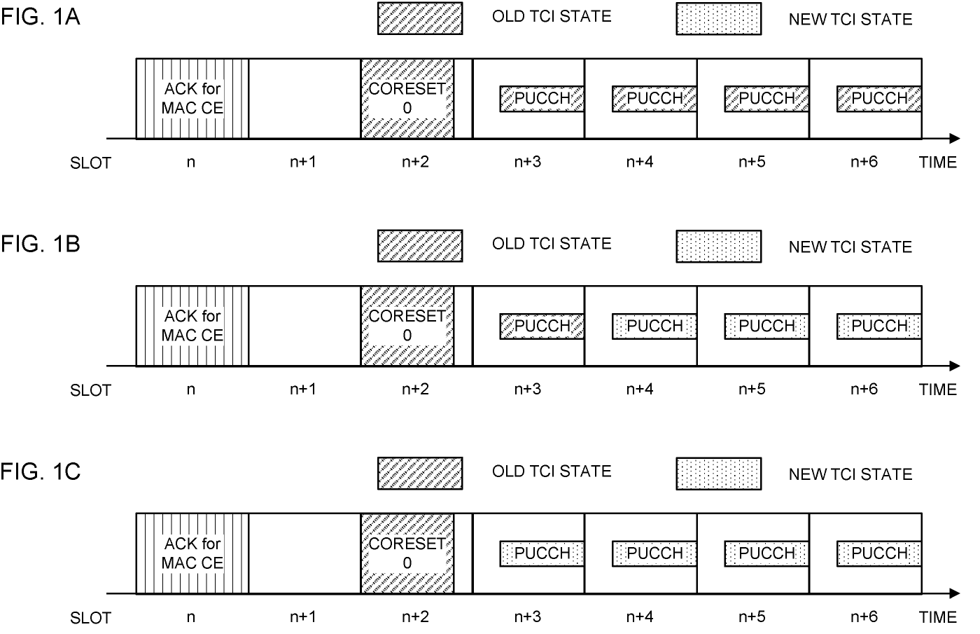

FIGS. 1A to 1C are diagrams illustrating examples of a default spatial relation of multiple slots according to an embodiment. In this example, an example of slot = 1 ms (subcarrier spacing = 15 kHz) is shown for simplicity.

In this example, the UE, before slot n, received a MAC CE that designates (updates) the TCI state of CORESET 0, and in slot n, transmitted an HARQ-ACK for a PDSCH transmitting the MAC CE. Further, the UE is configured to perform multi-slot PUCCH transmission over 4 slots from slot n+3 to slot n+6.

In the specifications of Rel. 15/16 until now, the updating of the TCI state based on the MAC CE is applied from the first slot among those in the period of 3 ms or later after slot n. CORESET 0 of slot n+2 corresponds to the old (pre-updated) TCI state, as shown in the drawing. Although not illustrated, CORESET 0 of slot n+4 or later corresponds to the new (post-updated) TCI state. Thus, in this example, multi-slot PUCCHs cross over the updating timing of the TCI state of CORESET 0.

FIGS. 1A to 1C show cases where the default spatial relation of each slot is determined in accordance with the above (1) to (3), respectively.

In FIG. 1A, the UE applies the default spatial relation at the time of slot n+3, which is the first slot of the multiple slots, (the TCI state of CORESET 0 before TCI state updating is reflected) to the other slots, and transmits multi-slot PUCCHs.

In FIG. 1B, the UE applies the default spatial relation at the time of each slot of the multiple slots (which is, before TCI state updating is reflected, the TCI state of CORESET 0 before updating and is, after TCI state updating is reflected, the TCI state of CORESET 0 after updating) to the slot, and transmits multi-slot PUCCHs.

In FIG. 1C, the UE applies the default spatial relation at the time of slot n+6, which is the last slot of the multiple slots, (the TCI state of CORESET 0 after TCI state updating is reflected) to the other slots, and transmits multi-slot PUCCHs.

According to the one embodiment described above, the UE can appropriately determine a default spatial relation for repeated transmissions.

### Others

Note that although the above embodiments have described UL multi-slot transmission, the present invention is not limited thereto, and may be applied to DL multi-slot transmission (which is multi-slot reception from the UE’s point of view).

The following words in the above embodiments (the left side of the colon) may be replaced with the words on the right side of the colon (there may be words read as they are):
transmission: reception;
repeated transmission (multi-slot transmission): repeated reception, or multi-slot reception;
a spatial relation: a TCI state (a QCL assumption);
a default spatial relation: a default TCI state (a default QCL assumption), or a default TCI state (a default QCL assumption) for a PDSCH/PDCCH of repeated transmission (reception).

Further, each of the above embodiments may be used independently for each channel/signal, or may be used in common to a plurality of channels/signals. For example, the default spatial relations of a PUCCH/PUSCH/SRS may be determined by different methods, or may be determined by a common method.

Further, each of the above embodiments may be applied to UE that reports capability information indicating that the UE has a specific capability or supports the capability. The capability information may be capability information regarding the support of a default spatial relation/Path-loss RS; for example, may be capability information regarding the support of a default spatial relation/Path-loss RS for a dedicated PUCCH/SRS, or a PUSCH scheduled by DCI format 0_0.

Further, each of the above embodiments may be applied to a case where (the operation of) multiple TRPs or multiple panels are configured in the UE, or may be applied to other cases.

Note that the multi-slot PUSCHs in the present disclosure may be replaced with multi-slot PUSCHs that refer to a default spatial relation, without configuring a spatial relation of an SRS resource (use = a codebook or a non-codebook) corresponding to an SRI of PUSCHs.

Note that the multi-slot SRSs in the present disclosure may be replaced with SRSs that refer to a default spatial relation in an SRS resource in which multi-slot transmission is configured (or given in instruction or provided in notification), without configuring a spatial relation of the SRS resource. Note that the multi-slot SRSs may be limited to at least one of an A-SRS, a P-SRS, and an SP-SRS. Further, the multi-slot SRSs may be limited to an SRS corresponding to a specific use (for example, at least one of a codebook, non-codebook beam management, and antenna switching).

Note that (1) to (3) of the above embodiments are not limited to a default spatial relation/TCI state, and may be applied to a spatial relation/TCI state designated by DCI/MAC CE.

### Radio Communication System

Hereinafter, a configuration of a radio communication system according to one embodiment of the present disclosure will be described. In this radio communication system, communication is performed using one or a combination of the radio communication methods according to the herein-contained embodiments of the present disclosure.

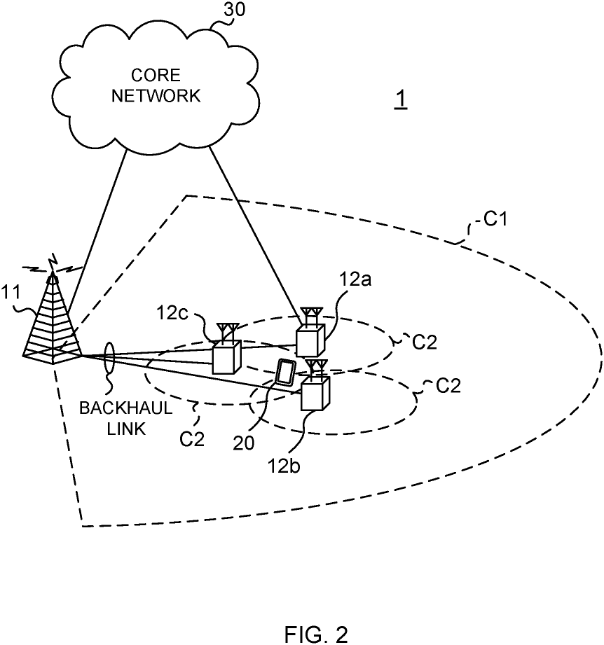

FIG. 2 is a diagram to show an example of a schematic structure of a radio communication system according to one embodiment. A radio communication system 1 may be a system that implements communication using long term evolution (LTE), 5th generation mobile communication system New Radio (5G NR), and the like drafted as the specification by third generation partnership project (3GPP) .

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC) ) .

The radio communication system 1 may include a base station 11 that forms a macro cell C1 with a relatively wide coverage, and base stations 12 (12a to 12c) that are arranged in the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10”, unless these are distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range (frequency range 1 (FR1)) and a second frequency range (frequency range 2 (FR2)). The macro cell C1 may be included in FR1, and the small cell C2 may be included in FR2. For example, FR1 may be a frequency band of 6 GHz or less (sub-6 GHz), and FR2 may be a frequency band higher than 24 GHz (above-24 GHz). Note that the frequency ranges, definitions, and the like of the FR1 and FR2 are not limited thereto, and, for example, FR1 may correspond to a frequency range higher than FR2.

Further, the user terminal 20 may perform communication on each CC using at least one of time division duplex (TDD) and frequency division duplex (FDD).

The plurality of base stations 10 may be connected to each other in a wired manner (for example, an optical fiber, an X2 interface, or the like in compliance with common public radio interface (CPRI)) or in a wireless manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), and the like.

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that, in the radio communication system 1, another radio access method (for example, another single carrier transmission method or another multi-carrier transmission method) may be used as the UL and DL radio access methods.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by the user terminals 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. User data, higher layer control information, and the like may be transmitted on the PUSCH. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

Note that, the DCI for scheduling the PDSCH may be referred to as DL assignment, DL DCI, or the like, and the DCI for scheduling the PUSCH may be referred to as UL grant, UL DCI, or the like. Note that, the PDSCH may be replaced with DL data, and the PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space on the basis of search space configuration.

One search space may correspond to a PDCCH candidate corresponding to one or more aggregation levels. One or more search spaces may be referred to as a search space set. Note that the terms “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), and scheduling request (SR) may be transmitted on the PUCCH. A random access preamble for establishing connection with a cell may be transmitted on the PRACH.

Note that, in the present disclosure, downlink, uplink, and the like may be expressed without “link”. Furthermore, various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals)”.

### Base Station

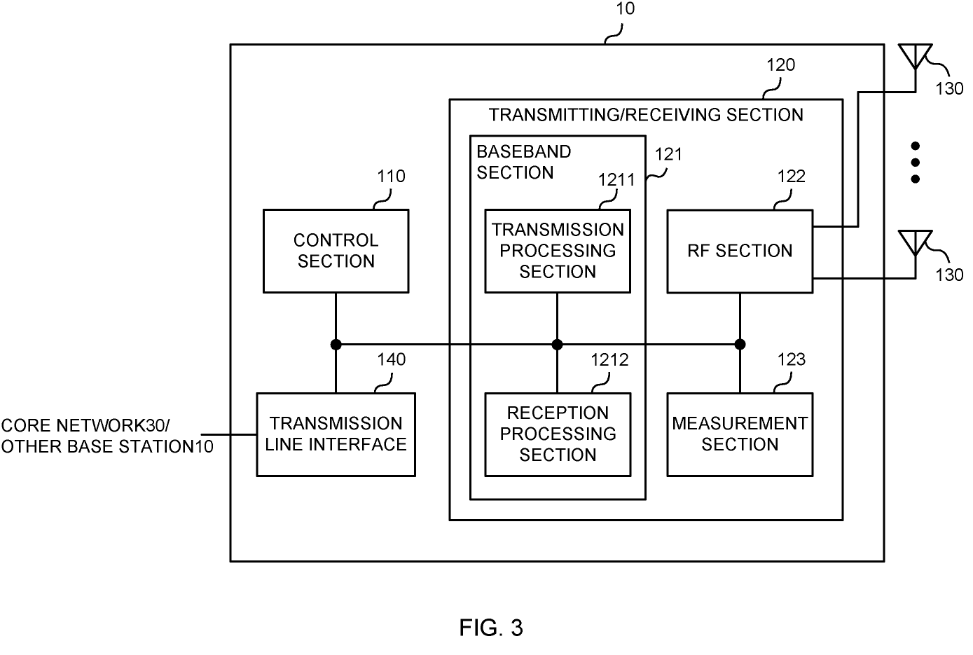

FIG. 3 illustrates one example of the configuration of a base station according to one embodiment. The base station 10 includes a control section 110, a transmitting/receiving section 120, a transmission/reception antenna 130, and a transmission line interface 140. Note that one or more control sections 110, one or more transmitting/receiving sections 120, one or more transmission/reception antennas 130, and one or more transmission line interfaces 140 may be provided.

Note that, although this example mainly describes functional blocks of a characteristic part of the present embodiment, it may be assumed that the base station 10 includes other functional blocks that are necessary for radio communication as well. A part of processing performed by each section described below may be omitted.

The control section 110 controls the entire base station 10. The control section 110 can include a controller, a control circuit, and the like, which are described on the basis of common recognition in the technical field related to the present disclosure.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be transmitted as a signal, control information, a sequence, and the like, and may transfer the data, the control information, the sequence, and the like to the transmitting/receiving section 120. The control section 110 may perform call processing (such as configuration or releasing) of a communication channel, state management of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 120 may be configured as an integrated transmitting/receiving section, or may include a transmitting section and a receiving section. The transmitting section may include the transmission processing section 1211 and the RF section 122. The receiving section may include the reception processing section 1212, the RF section 122, and the measurement section 123.

The transmission/reception antenna 130 can include an antenna, which is described on the basis of common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency range, filtering processing, amplification, and the like on the baseband signal, and may transmit a signal in the radio frequency range via the transmission/reception antenna 130.

Meanwhile, the transmitting/receiving section 120 (RF section 122) may perform amplification, filtering processing, demodulation to a baseband signal, and the like on the signal in the radio frequency range received by the transmission/reception antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM), channel state information (CSI) measurement, and the like on the basis of the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may perform transmission/reception of a signal (backhaul signaling) to/from an apparatus included in the core network 30, another base station 10, or the like, and may perform acquisition, transmission, or the like of user data (user plane data), control plane data, and the like for the user terminal 20.

Note that, the transmitting section and the receiving section of the base station 10 in the present disclosure may include at least one of the transmitting/receiving section 120, the transmission/reception antenna 130, and the transmission line interface 140.

Note that the transmitting/receiving section 120 may transmit, to the user terminal 20, information (for example, radio resource control (RRC) signaling, medium access control (MAC) signaling, and downlink control information (DCI)) for determining a default spatial relation to be applied to multi-slot transmission on the basis of a spatial relation to be applied to one or more slots of the multi-slot transmission.

The transmitting/receiving section 120 may receive, from the user terminal 20, the multi-slot transmission using a spatial domain transmission filter based on the default spatial relation.

### User Terminal

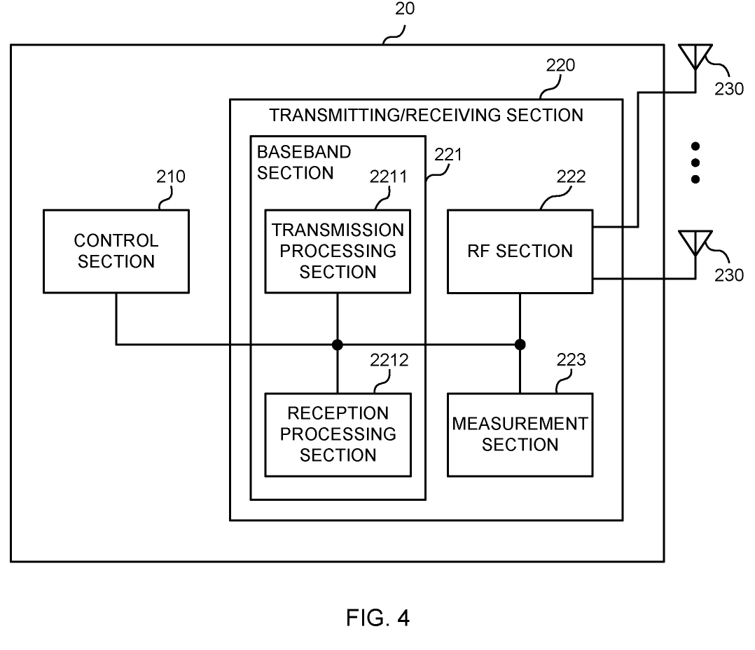

FIG. 4 illustrates one example of the configuration of user terminal according to an embodiment. The user terminal 20 includes a control section 210, a transmitting/receiving section 220, and a transmission/reception antenna 230. Note that one or more control sections 210, one or more transmitting/receiving sections 220, and one or more transmission/reception antennas 230 may be provided.

Note that, although this example mainly describes functional blocks of a characteristic part of the present embodiment, it may be assumed that the user terminal 20 includes other functional blocks that are necessary for radio communication as well. A part of processing performed by each section described below may be omitted.

The control section 210 controls the entire user terminal 20. The control section 210 can include a controller, a control circuit, and the like, which are described on the basis of common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data to be transmitted as a signal, control information, a sequence, and the like, and may forward the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmission/reception circuit, and the like, which are described on the basis of common recognition in the technical field related to the present disclosure.

The transmitting/receiving section 220 may be configured as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna, which is described on the basis of common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, or the like acquired from the control section 210 to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined on the basis of configuration of transform precoding. When transform precoding is enabled for a channel (for example, PUSCH), the transmitting/receiving section 220 (transmission processing section 2211) may perform DFT processing as the above-described transmission processing in order to transmit the channel by using a DFT-s-OFDM waveform, and if not, the DFT processing does not have to be performed as the transmission processing.

The transmitting/receiving section 220 (RF section 222) may perform modulation to a radio frequency range, filtering processing, amplification, and the like on the baseband signal, and may transmit a signal in the radio frequency range via the transmission/reception antenna 230.

Meanwhile, the transmitting/receiving section 220 (RF section 222) may perform amplification, filtering processing, demodulation to a baseband signal, and the like on the signal in the radio frequency range received by the transmission/reception antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 220 (measurement section 223) may perform measurement on the received signal. For example, the measurement section 223 may perform RRM measurement, CSI measurement, and the like on the basis of the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the reception section of the user terminal 20 in the present disclosure may include at least one of the transmitting/receiving section 220 and the transmission/reception antenna 230.

Note that the control section 210 may determine a default spatial relation to be applied to multi-slot transmission on the basis of a spatial relation to be applied to one or more slots of the multi-slot transmission.

The transmitting/receiving section 220 may perform the multi-slot transmission by using a spatial domain transmission filter based on the default spatial relation. Note that the multi-slot transmission may be repeated transmission of at least one of a physical uplink shared channel (PUSCH), a physical uplink control channel (PUCCH), and a measurement reference signal (sounding reference signal (SRS)).

The control section 210 may determine a PL-RS corresponding to the default spatial relation, and may control the power of the multi-slot transmission on the basis of the PL-RS.

The control section 210 may determine the default spatial relation on the basis of the spatial relation of the first slot of the multi-slot transmission.

The control section 210 may determine the default spatial relation on the basis of the spatial relation of each slot of the multi-slot transmission.

The control section 210 may determine the default spatial relation on the basis of the spatial relation of the last slot of the multi-slot transmission.

### Hardware Configuration

Note that the block diagrams that have been used to describe the above embodiments illustrate blocks in functional units. These functional blocks (components) may be implemented in arbitrary combinations of at least one of hardware and software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a wireless manner, or the like, for example) and using these apparatuses. The functional block may be achieved by combining the one device or the plurality of devices with software.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, assigning, and so on. For example, a functional block (component) that has a transmission function may be referred to as a transmitting section (transmitting unit), a transmitter, and the like. In any case, as described above, the implementation method is not particularly limited.

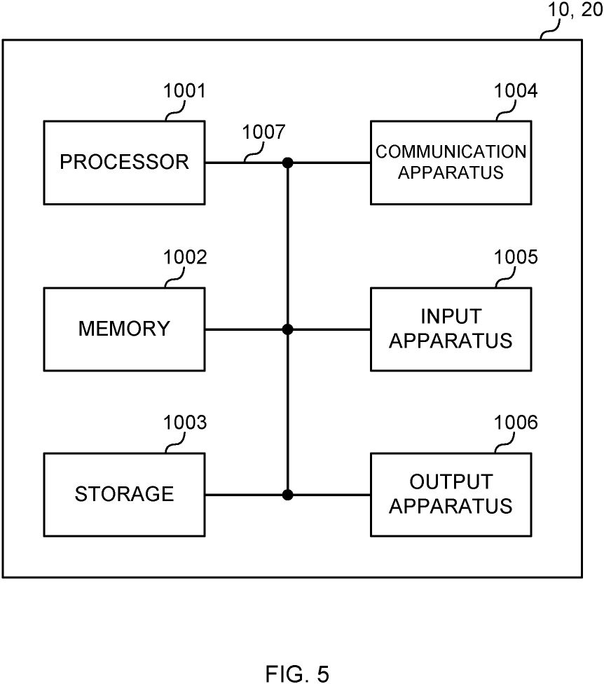

For example, the base station, the user terminal, or the like according to one embodiment of the present disclosure may function as a computer that executes the processing of the radio communication method in the present disclosure. FIG. 5 illustrates one example of the hardware configuration of a base station and a user terminal according to an embodiment. Physically, the above-described base station 10 and user terminal 20 may be configured as a computer apparatus that includes a processor 1001, a memory 1002, a storage 1003, a communication apparatus 1004, an input apparatus 1005, an output apparatus 1006, a bus 1007, and the like.

In the present disclosure, the terms such as an apparatus, a circuit, a device, a section, or a unit can be replaced with each other. The hardware configuration of the base station 10 and the user terminal 20 may include one or more of each of the apparatuses illustrated in the drawings, or does not have to include some apparatuses.

For example, although only one processor 1001 is shown, a plurality of processors may be provided. Further, the processing may be executed by one processor, or the processing may be executed by two or more processors simultaneously or sequentially, or by using other methods. Note that the processor 1001 may be implemented with one or more chips.

Each function of the base station 10 and the user terminal 20 is implemented by, for example, reading predetermined software (program) into hardware such as the processor 1001 and the memory 1002, and by controlling the operation in the processor 1001, the communication in the communication apparatus 1004, and at least one of the reading and writing of data in the memory 1002 and the storage 1003.

The processor 1001 may control the whole computer by, for example, running an operating system. The processor 1001 may be configured by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

Furthermore, the processor 1001 reads programs (program codes), software modules, data, and so on from at least one of the storage 1003 and the communication apparatus 1004 into the memory 1002, and executes various processing according to these. As the program, a program that causes a computer to execute at least a part of the operation described in the above-described embodiment is used. For example, the control section 110 (210) may be implemented by a control program that is stored in the memory 1002 and that operates on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), and other appropriate storage media. The memory 1002 may be referred to as a register, a cache, a main memory (primary storage apparatus), and the like. The memory 1002 can store a program (program code), a software module, and the like, which are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disc, a Blu-ray (registered trademark) disk), a removable disk, a hard disk drive, a smart card, a flash memory device (for example, a card, a stick, or a key drive), a magnetic stripe, a database, a server, and other appropriate storage media. The storage 1003 may be referred to as “secondary storage apparatus”.

The communication apparatus 1004 is hardware (transmitting/receiving device) for performing inter-computer communication via at least one of a wired network and a wireless network, and for example, is referred to as “network device”, “network controller”, “network card”, “communication module”, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmission/reception antenna 130 (230), and the like described above may be implemented by the communication apparatus 1004. The transmitting/receiving section 120 (220) may be implemented in a physically or logically separated manner by the transmitting section 120a (220a) and the receiving section 120b (220b).

The input apparatus 1005 is an input device for receiving input from the outside (for example, a keyboard, a mouse, a microphone, a switch, a button, a sensor, and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus, including the processor 1001, the memory 1002, and so on are connected by the bus 1007 so as to communicate information. The bus 1007 may be formed with a single bus, or may be formed with buses that vary between pieces of apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by the hardware. For example, the processor 1001 may be implemented with at least one of these pieces of hardware.

### Variations

Note that terms described in the present disclosure and terms necessary for understanding the present disclosure may be replaced with terms that have the same or similar meanings. For example, a channel, a symbol, and a signal (signal or signaling) may be replaced interchangeably. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may be formed with one or more durations (frames) in the time domain. Each of the one or more periods (frames) included in the radio frame may be referred to as a subframe. Further, the subframe may include one or more slots in the time domain. A subframe may be a fixed time duration (for example, 1 ms) that is not dependent on numerology.

Here, the numerology may be a communication parameter used for at least one of transmission and reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, specific windowing processing performed by a transceiver in the time domain, and the like.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

A slot may include a plurality of minislots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or PUSCH) transmitted using a minislot may be referred to as “PDSCH (PUSCH) mapping type B”.

A radio frame, a subframe, a slot, a minislot and a symbol all represent the time unit in signal communication. The radio frame, the subframe, the slot, the mini slot, and the symbol may be called by other applicable names, respectively. Note that time units such as a frame, a subframe, a slot, a minislot, and a symbol in the present disclosure may be replaced with each other.

For example, one subframe may be referred to as a TTI, a plurality of consecutive subframes may be referred to as a TTI, or one slot or one mini slot may be referred to as a TTI. That is, at least one of the subframe and the TTI may be a subframe (1 ms) in the existing LTE, may be a period shorter than 1 ms (for example, one to thirteen symbols), or may be a period longer than 1 ms. Note that the unit to represent the TTI may be referred to as a “slot”, a “mini slot”, and so on, instead of a “subframe”.

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be the transmission time unit of channel-encoded data packets (transport blocks), code blocks, codewords, and so on, or may be the unit of processing in scheduling, link adaptation, and so on. Note that when TTI is given, a time interval (for example, the number of symbols) in which the transport blocks, the code blocks, the codewords, and the like are actually mapped may be shorter than TTI.

Note that, when one slot or one minislot is referred to as a “TTI”, one or more TTIs (that is, one or more slots or one or more minislots) may be the minimum time unit of scheduling. Also, the number of slots (the number of minislots) to constitute this minimum time unit of scheduling may be controlled.

A TTI having a time duration of 1 ms may also be referred to as a usual TTI (TTI in 3GPP Rel. 8 to 12), a normal TTI, a long TTI, a usual subframe, a normal subframe, a long subframe, a slot, or the like. A TTI shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, etc.) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in the RB may be determined based on numerology.

Also, an RB may include one or more symbols in the time domain, and may be one slot, one minislot, one subframe or one TTI in length. One TTI, one subframe, and the like each may be formed with one or more resource blocks.

Note that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. The PRB may be defined in a BWP and numbered within that BWP.

The BWP may include a BWP for UL (UL BWP) and a BWP for DL (DL BWP). For the UE, one or more BWPs may be configured within one carrier.

At least one of the configured BWPs may be active, and the UE may not assume to transmit or receive a predetermined channel/signal outside the active BWP. Note that “cell”, “carrier”, and the like in the present disclosure may be replaced with “BWP”.

Note that the structures of radio frames, subframes, slots, minislots, symbols, and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

Furthermore, the information and parameters described in the present disclosure may be represented in absolute values, represented in relative values with respect to given values, or represented using other corresponding information. For example, a radio resource may be specified by a predetermined index.

The names used for parameters and so on in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names assigned to these various channels and information elements are not restrictive names in any respect.

The information, signals, and the like described in the present disclosure may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals, and the like can be output at least either from higher layers to lower layers, or from lower layers to higher layers. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and so on that are input may be transmitted to other pieces of apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, a MAC control element (CE).

Also, reporting of predetermined information (for example, reporting of information to the effect that “X holds”) does not necessarily have to be sent explicitly, and can be sent implicitly (for example, by not reporting this piece of information, or by reporting another piece of information, and so on).

Decisions may be made in values represented by one bit (0 or 1), may be made in Boolean values that represent true or false, or may be made by comparing numerical values (for example, comparison against a predetermined value).

Software, whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology and the wireless technology is included within the definition of a transmission medium.

The terms “system” and “network” used in the present disclosure can be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station and the base station subsystem that performs a communication service in this coverage.

In the present disclosure, the terms such as “mobile station (MS)”, “user terminal”, “user equipment (UE)”, and “terminal” can be used interchangeably.

A mobile station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station and the mobile station may be referred to as a transmitting apparatus, a receiving apparatus, a radio communication apparatus, and the like. Note that at least one of the base station and the mobile station may be a device mounted on a moving object, a moving object itself, and the like. The moving object may be a transportation (for example, a car, an airplane, or the like), an unmanned moving object (for example, a drone, an autonomous car, or the like), or a (manned or unmanned) robot. Note that at least one of the base station and the mobile station also includes an apparatus that does not necessarily move during a communication operation. For example, at least one of the base station and the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel and a downlink channel may be replaced with a side channel.

Likewise, the user terminal in the present disclosure may be replaced with a base station. In this case, the base station 10 may be configured to have the functions of the user terminal 20 described above.

In the present disclosure, an operation performed by a base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, regarding the methods described in the present disclosure, elements of various steps are presented using an illustrative order, and are not limited to the presented particular order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX® ), IEEE 802.20, Ultra-WideBand (UWB), Bluetooth®, or another appropriate radio communication method, a next generation system expanded based on these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on”.

Reference to elements with designations such as “first”, “second”, and so on as used in the present disclosure does not generally limit the number/quantity or order of these elements. These designations can be used in the present disclosure, as a convenient way of distinguishing between two or more elements. In this way, reference to the first and second elements does not imply that only two elements may be employed, or that the first element must precede the second element in some way.

The terms “judging (determining)” as used in the present disclosure may encompass a wide variety of actions. For example, “judging (determining)” may be interpreted to mean making judgements and determinations related to judging, calculating, computing, processing, deriving, investigating, looking up, search, inquiry (for example, looking up in a table, database, or another data structure), ascertaining, and so on.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory), and so on.

In addition, to “judge” and “determine” may be interpreted to mean making judgements and determinations related to resolving, selecting, choosing, establishing, comparing, and so on. In other words, to “judge” and “determine” may be interpreted to mean making judgements and determinations related to some action.

In addition, to “judge (determine)” may be replaced with “assuming”, “expecting”, “considering”, and so on.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

As used in the present disclosure, when two elements are connected, these elements may be considered “connected” or “coupled” to each other by using one or more electrical wires, cables, printed electrical connections, and the like, and, as a number of non-limiting and non-inclusive examples, by using electromagnetic energy having wavelengths in the radio frequency domain, microwave, and optical (both visible and invisible) regions, or the like.

In the present disclosure, the phrase “A and B are different” may mean “A and B are different from each other”. Note that the phrase may mean that “A and B are different from C”. The terms such as “leave” “coupled” and the like may be interpreted as “different”.

When the terms such as “include”, “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, when articles, such as “a”, “an”, and “the” are added in English translation, the present disclosure may include the plural forms of nouns that follow these articles.

Now, although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined on the basis of the description of claims. Thus, the description of the present disclosure is for the purpose of explaining examples and does not bring any limiting meaning to the invention according to the present disclosure.

1-6. (canceled)

7. A terminal comprising:
a processor that controls to apply a spatial relation to be applied to a first slot of a multi-slot transmission to each of other slots of the multi-slot transmission; and
a transmitter that performs the multi-slot transmission.

8. The terminal according to claim 7, wherein the spatial relation is a default spatial relation.

9. The terminal according to claim 7, wherein the multi-slot transmission is a multi-slot transmission of an uplink control channel (PUCCH).

10. The terminal according to claim 7, wherein the processor uses, as the spatial relation, a transmission configuration indication (TCI) state of a control resource set (CORESET) with a lowest index in an active downlink bandwidth part (BWP).

11. A radio communication method for a terminal, comprising:
controlling to apply a spatial relation to be applied to a first slot of a multi-slot transmission to each of other slots of the multi-slot transmission; and
performing the multi-slot transmission.

12. A base station comprising:
a processor that assumes that a spatial relation to be applied to a first slot of a multi-slot transmission is applied to each of other slots of the multi-slot transmission; and
a receiver that receives the multi-slot transmission.

13. A system comprising a terminal and a base station, wherein
the terminal comprises:
a processor that controls to apply a spatial relation to be applied to a first slot of a multi-slot transmission to each of other slots of the multi-slot transmission; and
a transmitter that performs the multi-slot transmission, and
the base station comprises:
a receiver that receives the multi-slot transmission.
